(19) United States
(12) Patent Application Publication
(10) Pub. No.: US 2002/0051136 A1
(43) Pub. Date: May 2, 2002

(54) Printer device

(76) Inventors: Shoji Kawamura, Tokyo (JP); Azuma Miyazawa, Tokyo (JP)

Correspondence Address: STRAUB & POKOTYLO, Bldg. 6, Suite 83, 1 Bethany Road, Hazlet, NJ, 07730, US

(21) Appl. No.: 09/853,045

(22) Filed: May 9, 2001

(30) Foreign Application Priority Data
Aug. 21, 2000 (JP) 2000-249921
Aug. 21, 2000 (JP) 2000-249922

(51) Int. Cl. B41B 1/00

(52) U.S. Cl. 358/1.1

(57) ABSTRACT

The present invention provides a printer device which is capable of, when there is no frame in which print control information is written exist in a storage medium such as a memory card, notifying a user by displaying a message to that effect on a display unit. A printer device comprises a mode setting unit capable of setting a print control mode in which print control information written corresponding to image information is read; a judging unit for judging whether or not a frame in which predetermined print control information is written exists when the print control mode is set; and a display control unit for displaying a message that the print control information is not set in any frame when it is judged that the print control information is not set in any frame.

This application claims benefit of Japanese Application Nos. 2000-249921 filed in Japan on Aug. 21, 2000 and 2000-249922 filed in Japan on Aug. 21, 2000, the contents of which are incorporated by this reference.

### BACKGROUND OF THE INVENTION

1. Field of the Invention

The present invention generally relates to a printer device, and more particularly to a printer device for printing image information photographed with and stored in an electronic photograph device based on the print control information written corresponding to such image information.

2. Description of the Related Art

In recent years, personal computers (hereinafter sometimes referred to as “PC”) and video recording devices have become widely popular, and various printer devices capable of printing images processed by or stored in these devices have been proposed. Demands of such printer devices are also increasing. In addition, desired are printer devices that are inexpensive and capable of high-quality printing. Moreover, demands are strong for miniature, light and portable printer devices as mobile printer devices for executing printing any time, any place.

Pursuant to such demands, recently, various printer devices have been proposed in which a memory card storing print object data such as image information is freely insertable thereto and which is capable of printing the image information, or image data stored in such memory card. Among the above, there is a printer device to which so-called DPOF (Digital Print Order Format); in other words, print control information, relating to the print object image data in such memory card is written therein and which is capable of printout based on such print control information. As this printer device automatically prints predetermined images (frames) in predetermined numbers pursuant to such print control information, it does not keep the user under restraint for a long period of time. Further, as the system of this printer device does not require a PC for controlling the instructions and operation of printing, it is extremely effective in terms of miniaturizing devices, and holds promise for the future.

As this type of printer device, for example, there is a printer system disclosed in Japanese Laid-Open Patent Publication No. H6-8537. According to this proposed printer system, when a memory card is set having a DPOF setting as a result of print control information setting (sometimes referred to as “print job”); that is, information prescribing in what order and the number of prints the card operation device is to print the image data, being written therein, the printer system foremost reads the print control information, reads the image data from the memory card in the order set forth by the print control information, and prints out in the number of prints designated with the print control information.

Moreover, prior to the start of printing, this printer system obtains the total number of prints set in the print control information and the number of sheets of recording paper housed in such printer system, and, when the number of sheets of recording paper is more than the total number of prints, the printer system instructs and executes the start of printing based on the print control information.

In addition, upon inserting the freely insertable memory card in the printer device, the printer system determines whether an image or a frame in which print control information is written exists. When an image in which print control information is written exists, the printer system judges whether to print based on such print control information, and then executes implementation processing based on such judgement processing results. Meanwhile, when such an image does not exist, some printer devices do not display messages and therefore would not display anything.

Nevertheless, if the user does not recognize the system operation where a message is displayed only when an image in which print control information is written in the memory card exists, there were cases where it is not possible to know whether a frame in which print control information is written actually exists. In other words, there is a problem in that the user is not able to recognize a state of no messages being displayed because there is no image in which print control information is written. There is also a possibility that the user may misunderstand this to be a malfunction of the printer device. Moreover, in aforementioned Japanese Laid-Open Patent Publication No. H6-8537, disclosed is a printer system which merely displays a warning message on the monitor for supplying recording paper when the number of sheets of recording paper is less than the number of prints during the printing operation. This reference does not disclose a display method for informing the user that an image in which print control information is written does not exist certainty.

Further, according to the printer system disclosed in Japanese Laid-Open Patent Publication No. H6-8537, although the printer system obtains the total number of prints set in the print control information prior to the start of printing, it does not display the obtained number of prints. Thus, there is a problem in that the user is not able to know the total number of prints prior to printing. Moreover, as there is no display informing the remaining number of sheets to be printed after the printing operation is started, there is a problem in that it is not possible to estimate the time until the printing is finished.

### SUMMARY OF THE INVENTION

Accordingly, the present invention was devised in view of the foregoing problems, and an object thereof is to provide a printer device capable of notifying a user by displaying via a display means that an image (frame) in which print control information is written does not exist in a storage medium such as a memory card.

In addition, another object of the present invention is to provide a printer device capable of allowing a user to take in the total number of prints by displaying the total number of prints.

The printer device according to the present invention comprises: mode setting means capable of setting a print control mode which prints image information based on the print control information written corresponding to the image information; distinguishing means for distinguishing the frame number to which the print control information is written and the frame number to which the print control information is not written upon the print control mode being set; calculating means for calculating the total number of prints to be printed from the number of prints set in the respective frame numbers distinguished as having the print control information written therein; and display means for displaying the total number of prints calculated when the print control mode is set, and displaying a message that the print control mode is not set when the print control mode is not set.

The printer device according to the present invention comprises: mode setting means capable of setting a print control mode for reading print control information written corresponding to the image information; judging means for judging whether a frame in which predetermined print control information is written exists upon the print control mode being set; and display control means for displaying a message that the print control information is not set in any frame when the judging means judges that the print control information is not set in any frame.

The printer device according to the present invention comprises: mode setting means for setting a print control mode which reads print control information written corresponding to image information; judging means for judging whether a frame in which the image information and print control information are written exists upon the print control mode being set; display means capable of displaying at least information of printing; and display control means for making the display means display a message that the print control information is not set in any frame when the judging means judges that the print control information is not set in any frame.

The above and many other objects, features, and advantages of this invention will become apparent from the ensuing detailed description of one preferred embodiment, which should be read in conjunction with the accompanying drawing.

### BRIEF DESCRIPTION OF THE DRAWING

FIG. 1 is a perspective view showing the overall structure of the printer device according to the present invention;

FIG. 2 is a cross section of the structure of the principle portion of the printer device depicted in FIG. 1;

FIG. 3 is a block diagram showing the electrical circuitry of the principle portion mounted on the printer device of FIG.

FIG. 4 is a diagram showing all of the display characters and display marks displayable on the display of FIG. 1;

FIG. 5 is a diagram showing a display example when the DPOF is set;

FIG. 5A is a diagram showing a display example when the DPOF is not set;

FIGS. 6, 6A, 6B and 6C are diagrams showing another display example representing that the DPOF has not been set in a 7-segment display;

FIG. 7 is a diagram showing a display example representing that the DPOF has not been set with a “0” in the 7-segment display;

FIG. 8 is a flowchart showing a characteristic control action example by the CPU built in the printer device;

FIG. 9 is a block diagram showing the electrical circuitry of the principle portion of the printer device capable of allowing a user to take in the total number of prints to be printed;

FIG. 10 is a diagram showing a display example displaying the total number of prints to be printed pursuant to the print control information employing the 7-segment display method;

FIGS. 10A, 10B and 10C are diagrams showing display examples displaying the total number of prints to be printed pursuant to the print control information employing the 7-segment display method and the decremental display of the number of prints during printing; and

FIG. 11 is a flowchart showing the characteristic control action example by the CPU built in the printer device of FIG. 9.

### DETAILED DESCRIPTION OF THE PREFERRED EMBODIMENT

The embodiments of the present invention are now described referring to the drawings.

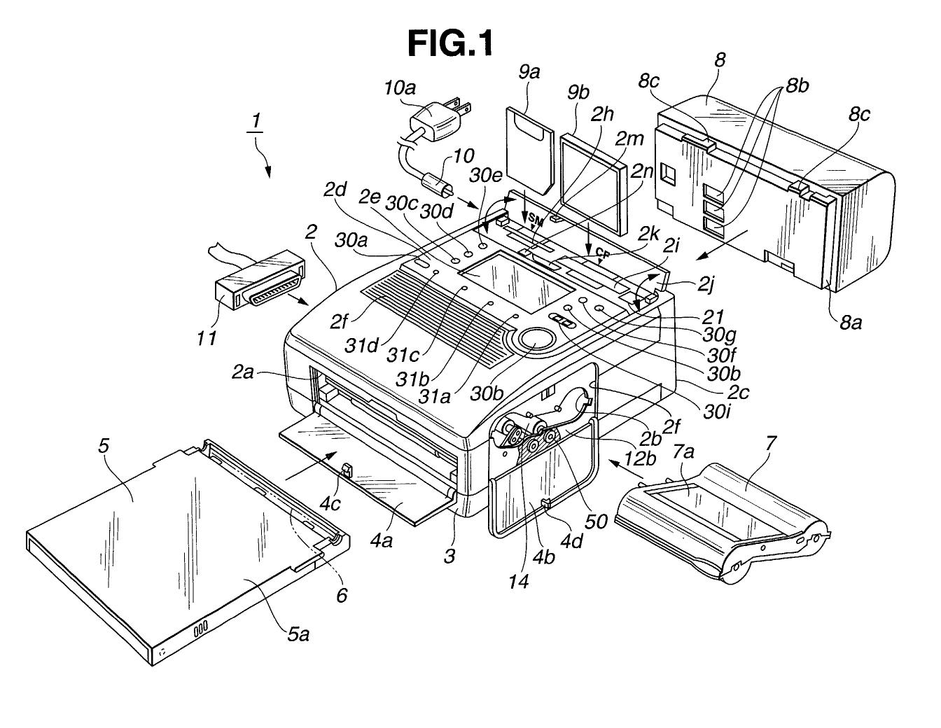

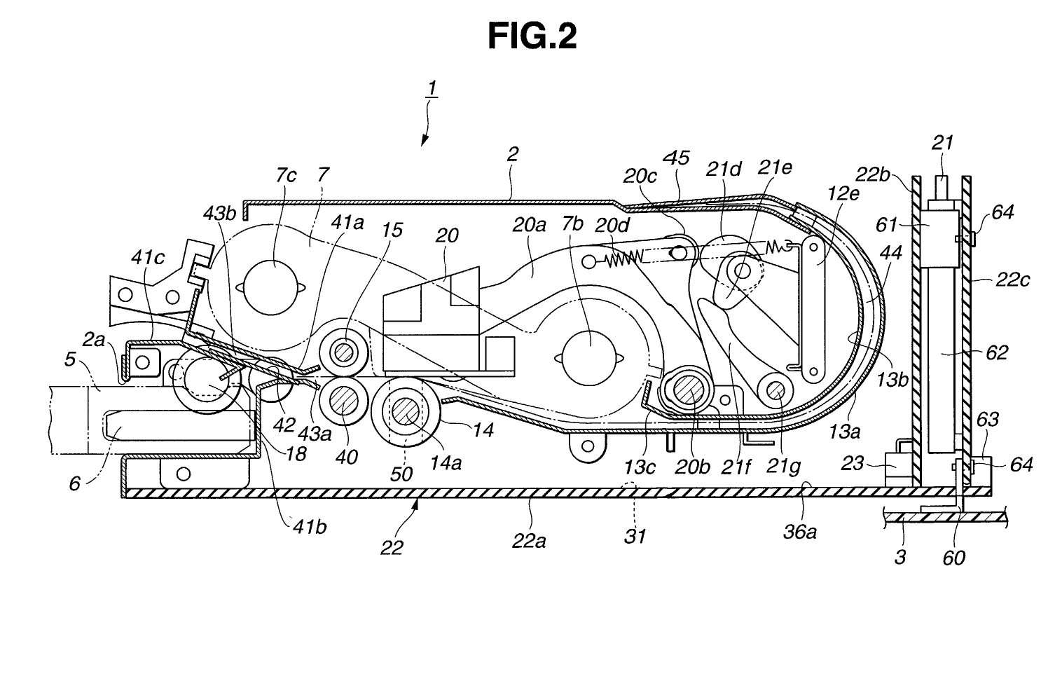

FIG. 1 and FIG. 2 are diagrams for explaining the schematic structure of the printer device employed in the present invention capable of printing image information photographed with an electronic photograph device. FIG. 1 is a perspective view showing the overall structure of the printer device. FIG. 2 is a cross section of the principle portion of the printer device.

As shown in FIG. 1, the printer device 1 of this embodiment comprises a body cover 2 for housing various mechanical mechanisms necessary for printing functions, structural components, substrates, etc.; and a body base 3 to be mounted below the body cover 2; thereby structuring the principle exterior portion of the device 1.

A paper feed cassette insertion slot 2a is formed on the body cover 2 at the front side (front-left part shown in the diagram) of the printer device 1 for inserting a paper feed cassette 5 capable of storing a plurality of recording paper 6, and the paper feed cassette 5 is thereby freely insertable via the paper feed cassette insertion slot 2a.

An opening lid 4a is openably provided to the part corresponding to the body base 3 for closing the paper feed cassette insertion slot 2a upon removing the paper feed cassette 5 from the device. This opening lid 4a is provided with a lock means 4c for retaining the closed state upon closing such lid 4a. The opening lid 4a is locked by the lock means 4c and the engagement means (not shown) provided at the position corresponding to the body cover 2.

An opening 2f is formed on the side face at the right side as viewed from the front side of the body cover 2, and an ink cassette insertion slot 2b for inserting an ink cassette 7 formed by an ink ribbon 7a being wound is formed on the main frame 12b exposed and disposed inside the device via the opening 2f. Moreover, heat transfer inks in a plurality of colors such as yellow (Y), magenta (M), cyan (C), transparent overcoat ink (OP) etc. have been successively and repeatedly applied to the ink ribbon 7a. In other words, a plurality of inks are applied in order (Y, M, C, OP) on a film-shaped substrate.

In addition, a closing lid 4b is closably provided to the body cover 2 for closing the opening 2f. Similar to the opening lid 4a described above, a lock means 4d is provided for retaining the closed state upon closing such lid 4b. The closing lid 4b is locked by the lock means 4d and the engagement means (not shown) provided at the position corresponding to the body cover 2.

A battery mounting groove 2c for freely mounting a battery 8 as the drive power source supply means necessary for portability is formed at the part on the back side (back-right part shown in the diagram) of the body cover 2. The mounting of the battery is realized by the mounting portion 8a formed on the mounting face of the battery 8 engaging with the battery mounting groove 2c. It is possible to retain the battery 8 in a mounted state by the engagement portion 8c provided at the upper part of the batter mounting portion 8a engaging with the engagement means (not shown) provided at the position corresponding to the battery mounting groove 2c.

Moreover, a plurality of battery contacts 8b for supplying the power stored in the battery 8 to the inside of the device 1 are formed on the face of the mounting portion 8a of the battery 8. Upon mounting the battery 8 on the battery mounting groove 2c, the battery contacts 8b are able to supply power to the inside of the device 1 by contacting and electrically energizing the battery intercepts (not shown) provided to the back face side of the printer device 1.

Provided on the upper face of the body cover 2 are the likes of an operation panel 2d, a display unit 2e which is a display means capable of displaying information of printing, insertion slots 2h, 2i of first and second memory cards which are both storage mediums, and the like. The operation panel 2d is structured by comprising operation buttons 30a˜30i as the instruction means for instructing execution orders of various control operations to the device 1, and display lamps 31a˜31d composed of LEDs (light emitting diodes) or the like for displaying light regarding the print operation progress.

The operation buttons 30a˜30i comprise a power source button 30a for instructing the on/off of power, a print button 30b for instructing the print operation, a print mode setting button 30c for setting or selecting the print mode (standard print, index print, all frame print, DPOF print, etc.), a sharpness button 30d for selecting the image quality (standard, soft, sharp), a division button 30e for selecting the number of divisions of division printing (no division, 2, 4, 9, 16 image planes), a date button 30f for designating the print date and format thereof, a card switching button 30g for switching the memory card 9 which is a storage medium, a frame number/print quantity switching button 30h for switching between the print frame number designation mode and the print quantity (number of copies) designation mode, (+) and (−) button 30i for increasing and decreasing the frame number or number of prints, and the like.

Moreover, the display lamps 31a˜31d comprise a now-printing lamp 31a for displaying a light that printing is being executed, a ribbon/paper lamp 31b for displaying a light informing that there is no paper feed cassette or no recording paper, an error lamp 31c for displaying a light informing that the opening lid of the ribbon cassette is opened or there are errors in the communication, an access/charging lamp 31d for displaying a light informing the reading of data (access) from the memory card 9, as well as the start of charging when the power source is turned off by means of the power supply button 30a in a state where the charging battery (not shown) and the DC plug 10 are connected.

Further, the display unit 2e is disposed in the notch in the center of the operation panel 2d. This display unit 2e is, for example, a liquid crystal display (LCD), and displays the control processing content (print mode designation, image quality mode designation, division mode designation, memory card switching designation, print date designation, print date display format/switching designation, file name, frame number/print quantity designation, character display frame number or print quantity or no DPOF setting, remaining battery display, etc.) during the print operation by the device 1. Details will be explained below.

The first and second memory card insertion slots 9a, 9b are formed corresponding to the sockets (not shown) respectively provided inside the main body. Two differing first and second memory cards 9a, 9b having stored thereon image information signals, or image data (sometimes containing print control information) to be printed are respectively inserted via the first and second memory card insertion slots 2h, 2i. Further, the first and second memory cards 2h, 2i are freely insertable or attachable/detachable in the corresponding sockets. For example, Smart Media (registered trademark) is used as the first memory card 9a and COMPACTFLASH (registered trademark) is used as the second memory card 9b. The present invention does not limit the type or number of memory cards, and, other memory cards may be combined and used as a matter of course.

As described above, by inserting the first memory card 9a or the second memory card 9b into the respective slots (not shown) provided together with the first and second memory card insertion holes 2h, 2i, the printer device is able to incorporate image information signals and print control information necessary for printing from one of the memory cards 9.

Further, a dust cover 2j for covering the memory card insertion slots 2h, 2i is openably provided adjacent to the first and second memory card insertion slots 2h, 2i of the body cover 2. This dust cover 2j can be easily opened because the notch provided at a predetermined section of the body cover 2 facilitates pinching of the ends of the dust cover. By opening this dust cover 2j, the first and second memory card insertion slots 2h, 2i are exposed. Upon closing the dust cover 2j, the engagement nail 2m protrusively provided on the end of the opening/closing side of the dust cover 2j engages with the engagement hole 2n provided at the main body side, and it is thereby possible to prevent dust and the like from entering by closing the dust cover 2j.

Moreover, an eject button 21 for ejecting the second memory card 9b, such as a COMPACTFLASH for example, is provided adjacent to the second memory card insertion slot 2h. Upon ejecting the second memory card 9b, such second memory card 9b may be ejected by pressing the eject button 21.

Meanwhile, a DC plug 10 for converting a standard AC current into a direct current (DC) and supplying this to the inside of the device 1 is provided such that the DC plug 10 is attachable/detachable to the rear end of the side face at the opposite side to where the ink cassette insertion slot 2b is provided on the body cover 2. The DC plug 10 incorporates a general AC power source via the AC plug 10a, converts the incorporated AC power source into a direct current (DC) pursuant to an AC/DC converter (not shown) disposed inside the AC plug 10a or between the AC plug 10a and the DC plug 10, and supplies this as the driving power of the device 1 to the inside of the device.

In the printer device 1 of the present embodiment, in addition to incorporating the image information signals from the first and second memory cards 9a, 9b, it is also possible to incorporate image information signals from, for example, personal computers, video recording/playback devices and the like. In other words, a PC connector (not shown) for freely inserting a PC connector 11 connected to such personal computer or video recording/playback device is provided to the near side portion on the side face of the body cover 2. Therefore, in the printer device 1 of the present embodiment, it is possible to broaden the scope of use by incorporating various image information signals via the PC connector 11 connected to the various image devices in addition to the first and second memory cards 9a, 9b.

The paper feed cassette 5 used in the printer device 1 is capable of storing a plurality recording paper 6, and a removable cover 5a is provide on the top face thereof. The cover 5a is formed by cutting a notch at the tip portion of the insertion side of the paper feed cassette 5, and the uppermost layer of the plurality of recording paper 6 stored via such notch is exposed thereby. Upon inserting the paper feed cassette 5, a paper feed roller (not shown) disposed inside the printer device 1, wherewith the position thereof is determined by the tip portion of the paper feed cassette 5, contacts a single sheet of recording paper 6 exposed from the notch of the cover 5a. And, pursuant to the rotation of the paper feed roller, it is possible to deliver such single sheet of recording paper 6 inside the device with certainty.

Meanwhile, the substrate 22 is structured of a control circuit substrate 22a, a power source circuit substrate 22b and a medium socket unit substrate 22c. The control circuit substrate 22a is disposed at the bottom face side of the printer device 1 as shown in FIG. 2, and is equipped with at least a circuit group, for example, an IC circuit (not shown) for controlling the feed of the recording paper or an IC circuit (not shown) for controlling the ink ribbon movement, necessary for print operation. The power source circuit substrate 22b is mounted on the control circuit substrate 22a so as to be disposed at one side face of the printer device 1, and comprises a charging circuit capable of charging the battery 8. The medium socket unit substrate 22c is disposed on the power source circuit substrate 22b and back face side of the power substrate 22b, and is provided with slots 82a, 82b to which the first and second memory cards 9a, 9b are inserted.

The control circuit substrate 22a is connected to one end side of the power source circuit substrate 22b via a connecter 23 provided as a connection means at one end side of the control circuit substrate 22a as shown in the diagram. Moreover, the control circuit substrate 22a is also connected to one end side of the medium socket unit substrate 22c via a connecter 63 provided as a connection means at one end side of the control circuit substrate 22a. In other words, by the respective substrates being mounted as described above, the overall shape of the substrate 22 becomes an approximate L shape, which is a structural arrangement appropriate for the miniaturization of the device.

A circuit group, for example, an IC circuit (not shown) for controlling the feed of the recording paper or an IC circuit (not shown) for controlling the ink ribbon movement, necessary for print operation, as well as an image signal processing circuit and the like are provided on the control circuit substrate 22a. Further, a PC connector to which a PC connector 11 is freely insertable is disposed on the side end on top of the control circuit substrate 22a. Moreover, a plurality of connectors (not shown) for electrically connecting with various electronic components (not shown) mounted on the printer device 1 are disposed on the front face side end on top of the control circuit substrate 22a. Such circuits and connectors are electrically connected via a printing pattern 31 provided pursuant to the necessary wiring form on the control circuit substrate.

The power source circuit substrate 22b forms an L shape together with the control circuit substrate 22a pursuant to the connector 23, and is electrically connected to the various electronic components at the control circuit substrate side by such connector 23. Although not shown, a charging circuit and thermal head 20 for charging the battery 8 as well as a control IC circuit for controlling the thermal head drive mechanism and the like are disposed on the inside face of the power source circuit substrate 22b. Moreover, a connector (not shown) for electrically connecting the thermal head drive mechanism and large condensers etc. (not shown) is provided to the side face end portion of the power source circuit substrate 22b.

Meanwhile, as shown in FIG. 2, a first memory card socket (not shown) and a second memory card socket 62 are respectively mounted on the inside face of the medium socket unit substrate 22c with a mounting member 61. The mounting member 61 is mounted on the power source circuit substrate 22b. One face of the mounting member 61 engages with the medium socket unit substrate 22c with a screw 64, thereby fixing the respective sockets.

In addition, in order to secure some degree of strength against the pressing force arising pursuant to the insertion of the various memory cards, the end of the medium socket unit substrate 22c is fixed to a support member 60 mounted on the face of the body base 3 with a screw 64. In other words, it is possible to prevent damages to the devices by such pressing force arising pursuant to the insertion of the various memory cards 9a, 9b by mounting the medium socket unit substrate 22c on the support member 60.

Although not shown in the diagram, a connection member electrically connected to the charging circuit of the power substrate 22b is disposed at the back face side of the medium socket unit substrate 22c, and battery contacts for contacting and electrically connecting with the battery contacts 8b of the battery 8 are protrusively formed on such connection member. Therefore, when the battery 8 is mounted on the battery mounting groove 2c of the body cover 2, the battery contacts of the connection member contacts and connects with the battery contacts 8b of the battery 8, thereby allowing the power of the battery 8 to be internally supplied to the main body of the printer device 1.

According to the structure described above, the length of wires may be shortened and the printer device may be miniaturized and lightened, whereby an optimum portable printer device may be structured. Moreover, in consideration of the manufacturing process of the substrate, as the substrate 22 is structured of three substrates 22a, 22b and 22c, substrates can be respectively manufactured, and the assembly process thereof can also be carried out easily. Thus, it is possible to simplify the manufacturing process, which will significantly contribute to the reduction of costs.

The basic operation of the printer device with the aforementioned structure is now explained referring to FIG. 2.

As shown in FIG. 2, foremost, recording paper 6 on the uppermost layer stored in the paper feed cassette 5 is fed to the inside of the printer device 1 by the paper feed roller 18. Here, the recording paper 6 can be smoothly transferred by the rotation of the paper feed roller 18 since a member having a curved surface shape is provided at the printer device side base end of the paper feed cassette 5.

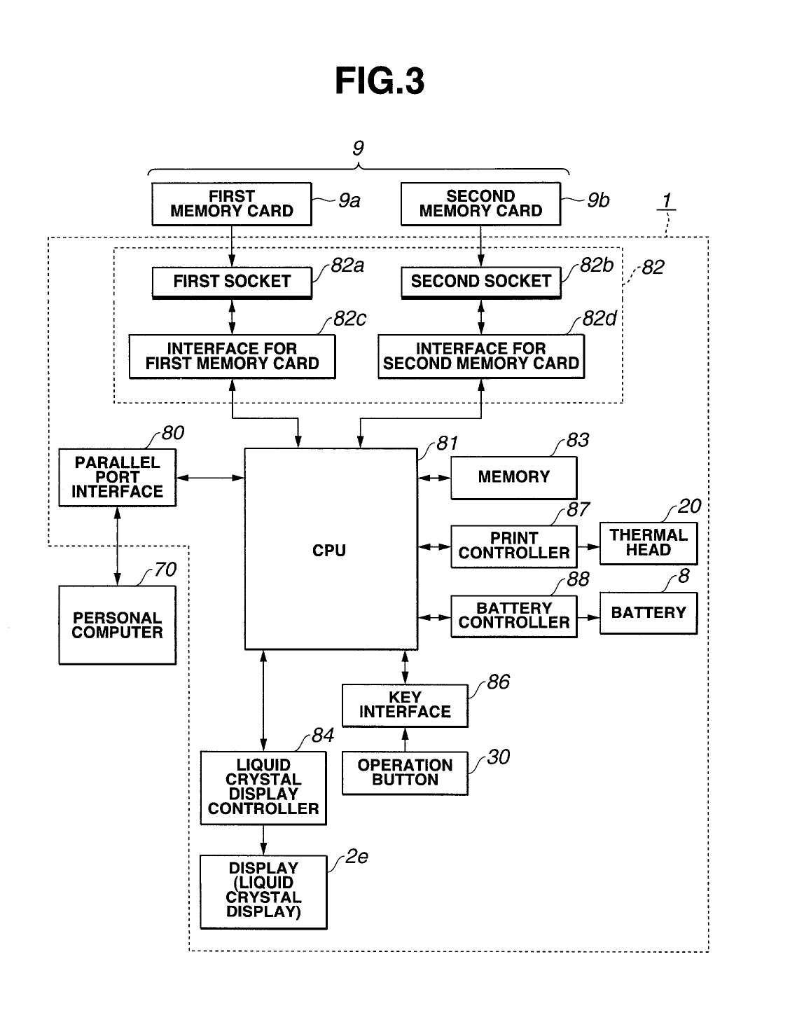

Guide plates 41a, 41b and 41c that form recording paper delivery paths 43a and 43b to which a main frame 12 is mounted are provided to the front step of the pinch roller 15 and grip roller 40 disposed at the front part inside the device. The recording paper 6 transferred with the paper feed roller 18 is delivered between the pinch roller 15 and grip roller 40 via the formed delivery path 43a while pushing the tape member 42 mounted on the guide plate 41c upward. Here, although not shown, a sensor which is a part of the recording paper delivery position detector mounted adjacent to the recording paper delivery path of the guide plate 41b detects whether the recording paper 6 is properly being delivered. In accordance with the detection results, the principle control unit (CPU 81, c.f. FIG. 3) provided to the control circuit substrate 22a determines whether to start the printing operation or not. When it is not being properly delivered, the CPU 81 makes the display unit 2e on the face of the body cover 2 display an error message or the like, and, when it is being properly delivered, the CPU 81 performs drive control in order to start the printing operation.

Upon starting the printing operation, the pinch roller 15 and the grip roller 40 sandwich the recording paper 6. And, the drive of the recording paper feeding/ribbon moving mechanism is controlled by the CPU 81, and the delivery of the recording paper 6 during printing is controlled by the rotational drive of the grip roller 40 to which a slip resistance means is dispensed on the surface thereof. In other words, the delivery of the recording paper 6 is controlled such that the front end portion of the recording paper 6 is delivered via the recording paper delivery path 44 formed by the guide plates 13a, 13b and the rear end portion of the recording paper 6 reaches the print start point in the thermal head 20 and the platen roller 14.

During printing, the recording paper 6 and the ink ribbon 7a are transferred by being pressed between the thermal head 20 and the platen roller 14 pursuant to the rotation of the grip roller 40 and the pinch roller 15. During such transfer, by flowing current to the heating element of the thermal head 20 with the control circuit provided on the power source circuit substrate 22b, the heat transfer ink of the ink ribbon 7a is dissolved or sublimed, and this is transferred to the recording paper 6 to execute printing. Simultaneously, during printing, the movement of the ink ribbon 7a necessary during printing is also controlled by the circuit for controlling the movement of the ink ribbon.

Here, upon printing yellow (Y) as the first color of the ink ribbon 7a on the recording paper 6, the pinch roller 15 and grip roller 40 transfer the recording paper 6 to the left side direction in the diagram, the recording paper 6 and ink ribbon 7a are pressed and transferred between the thermal head 20 and platen roller 14, and image information signals corresponding to yellow (Y) are supplied to the heating element (not shown) of the thermal head 20.

Moreover, the front end portion of the recording paper 6 at such time is in the recording paper delivery path 44 structured with the U-shaped guide plate 13a and the guide plate 13b of the same shape and disposed on the inside thereof. Meanwhile, the rear end portion of the recording paper 6 is transferred through the recording paper delivery path 43b during pressing the tape member 42 mounted on the guide plate 41c upward via the delivery path 43a, and the first color of printing is executed thereby.

Further, the position of the thermal head 20 during printing can be switched by the thermal head drive mechanism, for example, to three positions (upper position, lower position shown in the diagram, and partial position in a stand-by state between such upper and lower positions). The position thereof is controlled by the CPU 81 in accordance with the printing operation.

Then, after the printing of the first color yellow (Y) on the recording paper 6 is completed, the CPU 81 controls the drive of the thermal head drive mechanism 21 and makes the thermal head 20 move away from the platen roller 14 and transfers it to the partial position. Moreover, the pinch roller 15 and the grip roller 40 return the recording paper 6 to the rear (right side direction in the diagram) of the printer device 1, and thereafter repeats the aforementioned steps to execute color printing by successively layering the respective colors on the recording paper 6 in the order from the second color of magenta (M), third color of cyan (C), and a transparent overcoat (OP)

During the time until the printing of the respective colors is started, the recording paper 6 is transferred to the rear direction (right side direction in the diagram) of the printer device 1 by the grip roller 40 and the pinch roller 15. Here, the front end portion of the recording paper 6 is transferred while by guided with in the recording paper delivery path 44 formed by the U-shaped guide plates 13a, 13b, and the rear end portion of the recording paper 6 is detected by the sensor (not shown). Then, pursuant to the rotational control of the pinch roller 15 and grip roller 40 based on such detection results, the rear end portion of the recording paper 6 is set between the print start position between the thermal head 20 and the platen roller 14.

Further, upon the heat resistive element of the thermal head 20 transferring the respective heat transfer inks of the ink ribbon 7a on the recording paper 6, there are cases when the contact position of the platen roller 14 to the heat resistive element of the thermal head 20 is not at a proper position; that is, a displacement may occur. In such a case, by driving a pair of pushes 50 corresponding to such displacement among a plurality of pushes, it is possible to bias the central position of the rotational axis of the platen roller 14 and make adjustments to the proper position thereby.

When the printing of all colors is finished, the printed recording paper 6 is discharged to the outside of the device via the recording paper delivery path 43b pursuant to the paper feeding mechanism (not shown) for discharging the paper, and the printing operation is finished thereby. Discharge of the recording paper 6 after finishing printing is detected by another sensor as the recording paper delivery position detector. The finished timing of printing for 1 image plane is recognized by such detection results being supplied to the CPU 81.

Incidentally, in the printer device as described above, when image information signals to be printed are read from the first memory card 9a or the second memory card 9b, there are cases when print control information on the number of prints; in other words, information relating to DPOF and the like corresponding to the image information signals photographed by and stored in the electronic photograph device is written in the selected memory card 9.

In such a case, in the related art, with a printer device that does not display any message or the like when no photographic frame in which print control information is written exists, if the user does not recognize the system operation where a message is displayed only when a photographic frame in which print control information is written exists, there were cases where it is not possible to know whether a frame in which print control information written actually exists, and the user may misunderstand this to be a malfunction of the printer device.

Thus, the CPU 81 of the printer device according to the present embodiment judges whether a frame in which print control information is written exists corresponding to the image information when the memory card 9 is inserted. When a frame in which print control information is written exits, the CPU 81 judges on whether to print or not based on the print control information, and, thereafter, when it judges that printing is to be executed, temporarily accumulates the print object image data sent from the memory card 9 in the buffer memory within the printer device. The CPU 81 then reads image data of the print object corresponding to the frame in which print control information is written, and non-periodically prints out based on such print control information. Meanwhile, when a frame in which print control information is written does not exist, the CPU 81 makes a display that a frame in which print control information is written does not exist in the memory card; in other words, make the display unit display a message that print control information is not set in any frame. Embodiments for realizing the above are shown in FIGS. 3 through 8.

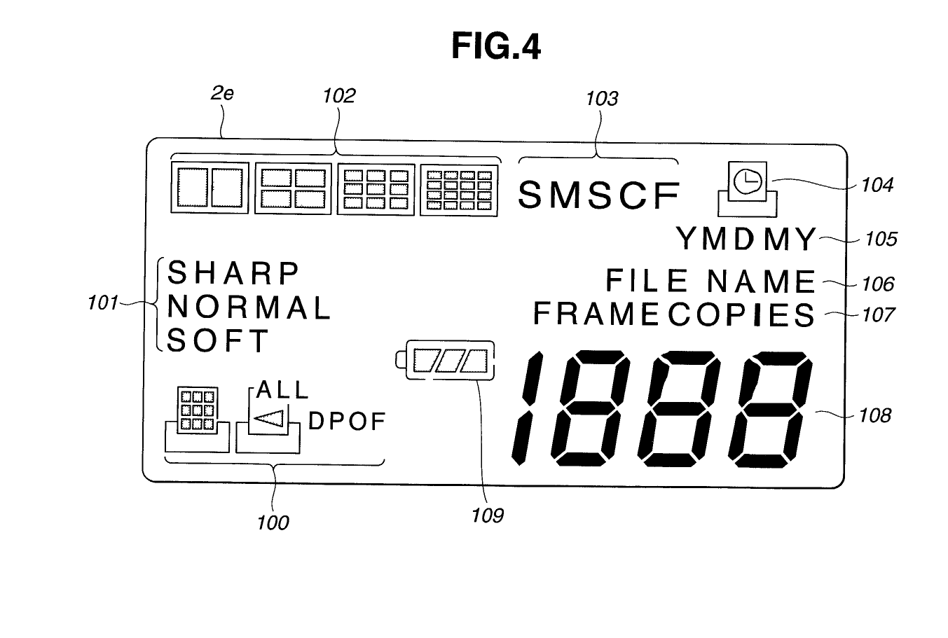

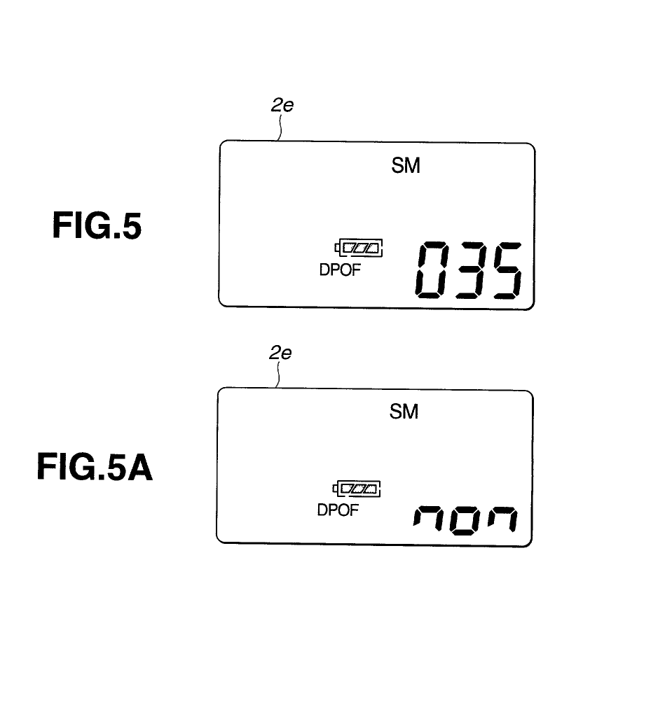

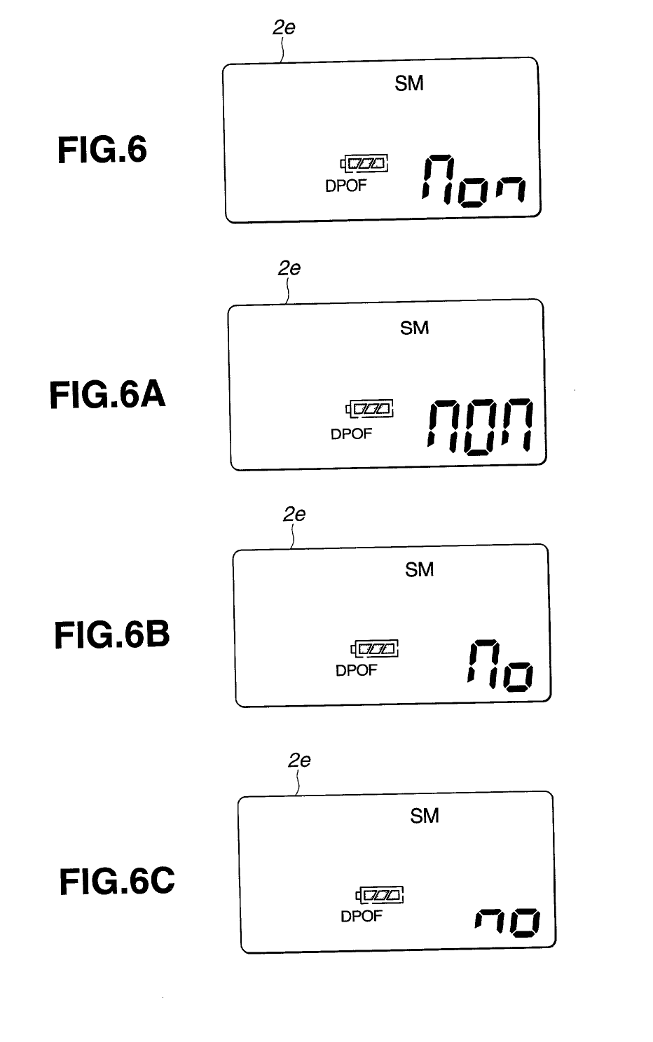

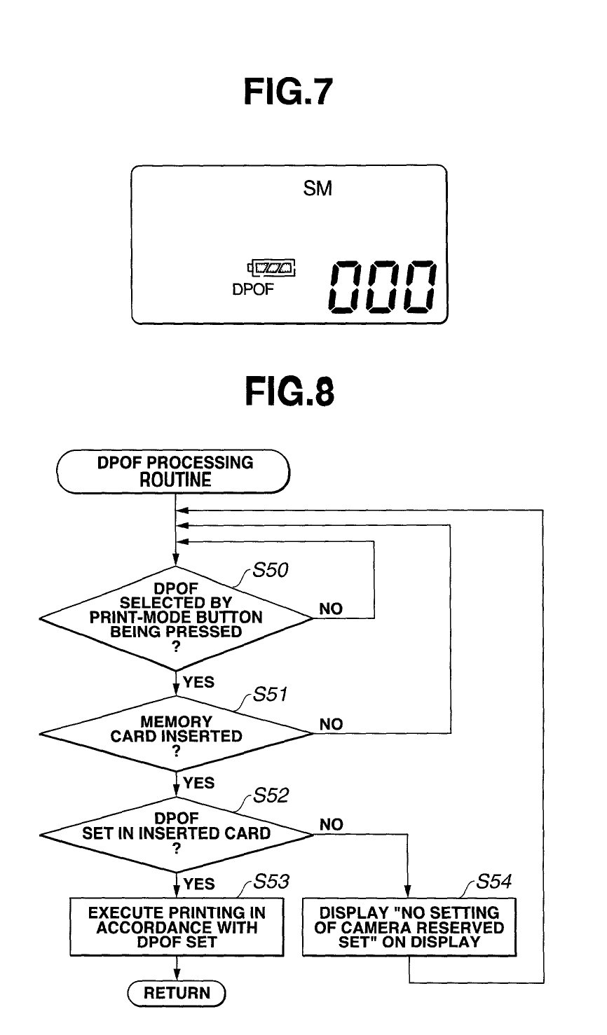

FIGS. 3 though 8 show one embodiment of the printer device according to the present invention. FIG. 3 is a block diagram depicting the electrical circuitry of the principle portion mounted on the device shown in FIG. 1. FIG. 4 is an indicator chart showing every display character and display mark displayable on the display unit. FIG. 5 is an indicator chart depicting a display example of the display unit based on the judgment results of whether or not a DPOF has been set. FIG. 5 is an indicator chart showing a display example in the case when DPOF has been set. FIG. 5A is an indicator chart showing a display example in the case when a DPOF characteristic to the present invention is not set. FIGS. 6, 6A, 6B and 6C are indicator charts showing display examples showing another display example representing that the DPOF has not been set in a 7-segment display. FIG. 7 is an indicator chart showing a display example representing that the DPOF has not been set with a “0” in the 7-segment display. FIG. 8 is a flowchart showing a characteristic control action example by the CPU incorporated in the printer device.

The CPU 81 of the printer device 1 shown in FIG. 3 reads the image information signals when the first memory card 9a or the second memory card 9a storing image information signals to be printed is inserted in the print control mode reading unit 82. The CPU 81 judges whether a frame in which print control information is written exists from such read image information signals. When a frame in which print control information is written exits, the CPU 81 judges on whether to print or not based on the print control information, and, thereafter, when it judged that printing is to be executed, temporarily accumulates the print object image data sent from the memory card 9 in the buffer memory within the printer device. The CPU 81 then reads image data of the print object corresponding to the frame in which print control information is written, and non-periodically prints out based on such print control information. Meanwhile, when a frame in which print control information is written does not exist, the CPU 81 makes a display that a frame in which print control information is written does not exist in the memory card 9; in other words, makes the display unit 2e display a message that print control information is not set in any frame. FIG. 3 shows the principle structural elements necessary for such operation.

As shown in FIG. 3, the printer device 1 is structured by comprising at least a parallel port interface 80, a CPU 81 as the display control means, a print control mode reading unit 82 as the print control mode setting means, a memory 83, a liquid display controller 84, an operation button 30, a key interface 86, a print controller 87, a battery controller 88, a thermal head 20, a battery 8 and a display unit 2e.

The parallel port interface 80 is connected to a personal computer 70, and is a communication means for giving and receiving electronic data to and from the personal computer 70. When the printer device 1 is to incorporate image signals of the print object from the personal computer 70, image data is incorporated into the printer device via the parallel port interface 80.

The print control mode reading unit 82 is structured by comprising first and second sockets 82a, 82b, and first and second memory card interfaces 82c, 82d. The first and second memory cards 9a, 9b are freely insertable in the first and second sockets 82a, 82b. When one of the memory card 9a, 9b is inserted, image signals of print objects and print control information from such memory card are read in the device or written or the like into such memory card.

A first memory card 9a such as a Smart Media is attachably inserted in the first socket 82a freely. Image signals of print objects or print control information stored in the first memory card 9a may be incorporated into the CPU pursuant to the interface 82c for the first memory card electrically connected to the first socket 82a. Moreover, the CPU 81 is also capable of supplying image signals etc. for writing into the first memory card 9a via the first socket 82a pursuant to the interface 82c for the first memory card.

Further, a second memory card 9b such as a COMPACTFLASH is attachably inserted in the second socket 82b freely. Image signals of print objects or print control information stored in the second memory card 9b may be incorporated into the CPU pursuant to the interface 82d for the second memory card electrically connected to the second socket 82b. Moreover, the CPU 81 is also capable of supplying image signals etc. for writing into the second memory card 9b via the first socket 82b pursuant to the interface 82d for the second memory card.

The memory 83 is a storage means for storing image signals of print objects from the first or second memory cards 9a, 9b under the control of the CPU 81 or data read from the personal computer 70.

The liquid crystal display control 84 is for controlling the display image in the display unit 2e by supplying liquid crystal display signals and liquid crystal display control signals to a display unit 2e such a liquid crystal display as the display means under the control of the CPU 81.

The key interface 86 is an interface for communicating the instruction signals from the operation button 30 to the CPU 81. For example, when the DPOF mode (the DPOF mode which executes contents set on the camera side), which is the print control mode, is selected by the print mode designation button 30c being pressed, instruction signals depicting the execution of this DPOF mode are supplied to the CPU 81. When this print control mode is set, printing of image information is printed based on print control information written corresponding to the image information. Moreover, as described above, the operation button 30 is structured by comprising a power source button 30a, a print button 30b, a print mode setting button 30c, a sharpness button 30d, a division button 30e, a date button 30f, a card switching button 30g, a frame number/print quantity switching button 30h, a (+) and (−) button 30i, and the like (c.f. FIG. 1), and instruction signals corresponding to the operated button are supplied to the key interface 86.

The print controller 87 supplies print signals and print control signals to the thermal head 20 as well as controls the printing operation, and also controls the drive of the recording paper feeding/ribbon moving mechanism (not shown) in accordance with the printing operation.

The battery controller 88 supplies power to the CPU 81 as well as communicates the remaining information of the battery 8 to the CPU 81.

The CPU 81 as the control means decodes the data of the various signals from the personal computer 70, decodes data of instruction signals from the operation button 30, decodes print control information from the first or second memory card 9a, 9b, stores print object image data from the personal computer 70 or the first or second memory card 9a, 9b in the image memory 83, makes the display unit 2e display messages, makes the thermal head 20 execute photographic printing, drives the paper feeding/ribbon moving mechanism (not shown), calculates the remaining amount of the battery 8, and the like.

Moreover, in the printer device 1 of the present embodiment, pursuant to the display control of the CPU 81, it is possible to display characters or marks on the display unit 2e as shown in FIG. 4. FIG. 4 is a diagram showing all of the display characters and display marks displayable on the display of FIG. 1.

For example, in the display example in FIG. 4, numeral 100 is the print mode designation display section, and a single mode among a standard print, index prints all frame print, and DPOF print may be suitably selected and the display thereof may by switched with the print mode button 30c. Moreover, numeral 101 is an image quality mode designation display section, and may be suitably selected and the display thereof may be switched with the sharpness button 30d. Numeral 102 is a division mode designation display section, and may be suitably selected and the display thereof may be switched with the division button 30e. Numeral 103 is a memory card designation display section, and may be suitably selected and the display thereof may be switched with the card switching button 30g. Numeral 104 is a print date designation display section, and numeral 105 is a print date display format switching designation display section, these may be suitably selected and the display thereof may be switched with the date button 30f. Numeral 106 is a file name display section. Numeral 107 is a frame number/print quantity designation display section, and may be suitably selected and the display thereof may be switched with the frame number/print quantity switching button 30h. Numeral 108 is the display switching display section of the frame number or print quantity, and may be suitably selected and the display thereof may be switched with the (+) and (−) button 30i. These display sections may be switched if required. Numeral 109 is a battery remaining amount display section for displaying the remaining amount of the battery. The characters and marks to be displayed on the display unit 2e are changed in accordance with the respective switching buttons. Further, displays showing the index print, all frame print and DPOF during the display upon print designation mode selection will be independently displayed, respectively, in a display mode as shown in FIG. 4. Nevertheless, with respect to the display showing a standard print, the standard print mode having been designated is displayed by turning off the 9 square displays within the index display at the left side of the diagram.

Next, control operations characteristic to the printer device shown in FIG. 3 are now described in detail referring to FIGS. 5 through 8.

The series of basic operations of the printer device 1 relating to printing as described in FIG. 2 are controlled based on the main routine of the CPU 81. With respect to the operational state during such main routine, for example, by the user suitably pressing the print mode selection button 30c within the operation button 30, if the print mode to be executed is selected to be a print control mode, that is, a DPOF mode, instruction signals showing the DPOF mode execution based on the operation of such operation button 30 is received by the key interface 86 and incorporated in the CPU 81. By recognizing such instruction signals, the CPU 81 activates the processing subroutine for executing the DPOF printing shown in FIG. 8.

The CPU 81 foremost judges whether the print mode to be executed by the print mode button being pressed is DPOF in the judgment processing at step S50, and advances the processing to the following step S51 when the DPOF mode is selected. If not, the CPU 81 returns the processing once again to step S50 and repeats such judgment of S50 until the DPOF mode is selected.

The judgment processing at step S51 judges whether a memory card 9a or 9b is inserted in a socket 82a or 82b. In other words, it judges whether the first memory card is inserted in the first socket 82a or whether the second memory card 9b is inserted in the second socket 82b. When either memory card is inserted in its corresponding socket, image signals of print objects and print control information stored in the memory card 9 are incorporated in the CPU 81 by the corresponding memory card interface 82c or 82d. Then, this is temporarily written into the memory 83 under the control of the CPU 81, and the processing proceeds to step S52. Here, when the print control information is read in the CPU 81, the print control information is stored in the memory within the CPU 81, and decoded. Meanwhile, when the memory card 9 is not inserted, the processing is returned to the judgment processing of S50.

Then, at the judgment processing of step S52, the CPU 81 judges whether a DPOF is set as the print control information in the inserted memory card 9. That is to say, the CPU 81 judges whether a frame in which predetermined print control information is written exists based on the data such as image signals of the respective frames of the print object read in the aforementioned processing. When there is a frame in which print control information is written, it is judged that a DPOF is set, and, at the processing of the succeeding step S53, for example, the liquid crystal display controller 85 is controlled so as to display on the display unit 2e a display, for example, as shown in FIG. 5. Thereafter, when the pressing of the print execution button 30b is confirmed, the CPU 81 controls the print controller 87 so as to print frames corresponding to the number of prints based on the decoded print control information, executes the print operation in the DPOF mode, and, after completion, proceeds to return.

Moreover, on the screen of the display unit 2e as shown in FIG. 5, “DPOF” showing that the DPOF mode is selected or set, which is a print control mode, a battery remaining amount display, and for example, a “035” for representing that the total number of prints is 35 in that the number of prints for each frame set as one of DPOF information on the camera side is summed up are displayed.

Meanwhile, at the judgment processing of step S52, when there is no frame in which print control information is written, it is judged that a DPOF is not set, and the processing proceeds to the step S54 and performed is the display processing characteristic to the present invention.

In other words, pursuant to this step S54, the CPU 81 controls the liquid crystal display controller 85 so as to display a message; for example, the display shown in FIG. 5A, on the display unit 2e that no frame contains print control information and that a DPOF is not set.

In the display shown in FIG. 5A, “DPOF” showing that the DPOF mode is selected, or set, which is a print control mode on the screen of the display unit 2e, a battery remaining amount display, and a “non” employing the 7-segment display method representing that the DPOF is not set are displayed.

Moreover, upon displaying a message utilizing the 7-segment display method that the DPOF is not set, the CPU 81 may also display on the display unit 2e “Non” or “NON” in which uppercase letters and lowercase letters are changed by utilizing three 7-segments as shown in FIG. 6 and FIG. 6A for example, or it may also display “No” or “no” in which uppercase letters and lowercase letters are changed by utilizing two 7-segments as shown in FIG. 6B and FIG. 6C.

Further, in addition to the character display of alphabets by using the 7-segment display method as described above, the CPU 81 may also display on the display unit 2e numerals such as “000” shown in FIG. 7 for example as a display that the DPOF is not set. Here, also considered may be “00” utilizing two 7-segments or “0” utilizing one 7-segment.

Needless to say, the selection of such displays may be set by freely switching the setting with the user device.

Thereafter, the CPU 81 returns the processing to step S50 after making the display unit 2e display a message that there is no camera reserve set information.

Therefore, when there is no print control information in any frame as described above, a display to such effect is made by displaying “non” or the like employing the 7-segment display method for example on the display unit 2e. Pursuant to this display, it is possible to let the user know with certainty that a frame in which print control information is written does not exist, and there is no fear that the user will misunderstand this to be a malfunction.

When the DPOF mode is selected pursuant to the display control of the CPU 81, “DPOF” showing the DPOF mode is displayed and a display such as “non” for the like employing the 7-segment display method for showing that there is no print control information in any frame is displayed adjacent to “DPOF”. The user is thereby able to recognize at a glance that no print control information exists in any frame.

Incidentally, in the aforementioned print device, there are cases when print control information such as print quantity information set corresponding to image information signals of the respective frames photographed by and stored in the electronic photograph device is written into the first memory card 9a or the second memory card 9b inserted in the device. Here, print operation is performed pursuant to the print control information by reading such print control information.

Upon executing the DPOF print mode as described above, in the related art, although it obtains the total number of prints set by the print control information prior to printing, it does not display the sought number of prints. Thus, there is a problem in that the user is not able to know the total number of prints prior to printing. Moreover, as there is no display informing the remaining number of sheets to be printed after the printing operation is started, there is a problem in that it is not possible to estimate the time until the printing is finished.

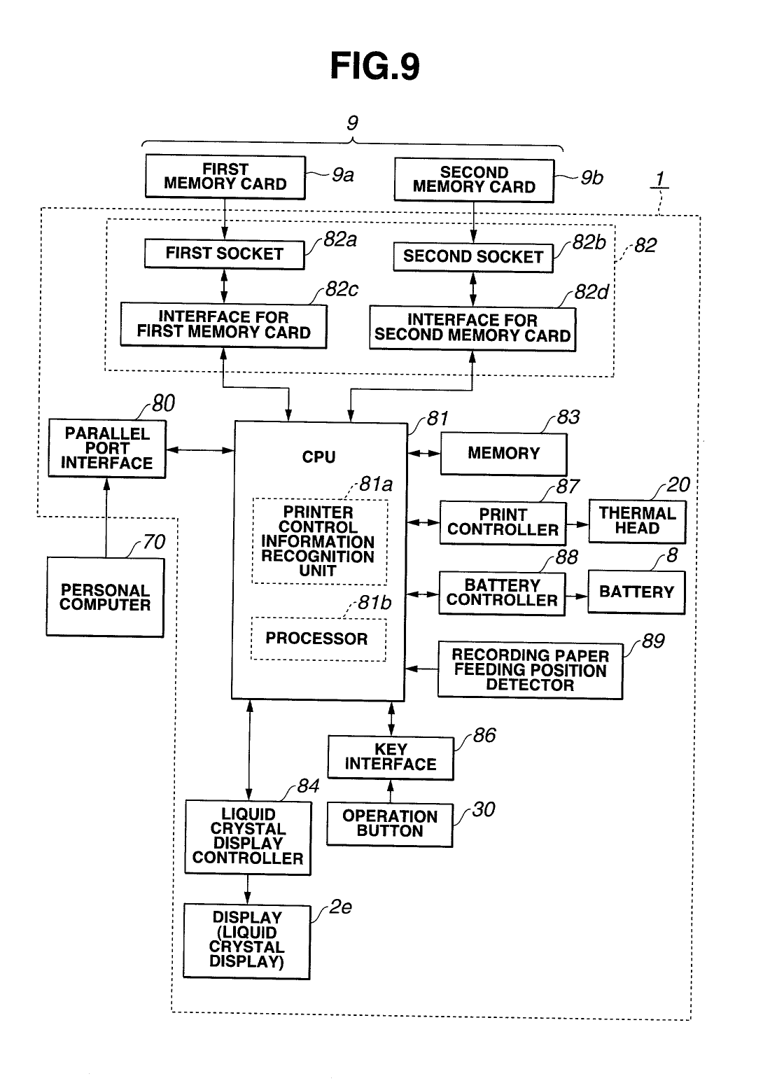

Thus, in the printer device of the present embodiment, when the first memory card 9a or the second memory card 9b is inserted, the frame numbers in which image information and print control information from such memory card 9 are recognized, and, thereafter, operation processing is performed for calculating and obtaining the total number of prints to be printed from the print quantity set in the respective frames into which print control information is written. The operated total number of prints is displayed on the displayed unit, the total number of prints to be printed decrements pursuant to the progress of the print operation after printing is started, and the decremental quantity value is displayed on the display unit so that a countdown is made. Thereby, it is possible to take in the total number of prints to be printed prior to the start of printing, and the time until the completion of printing may be forecast after the start of printing. The embodiment for realizing this is shown in FIGS. 9 through 11.

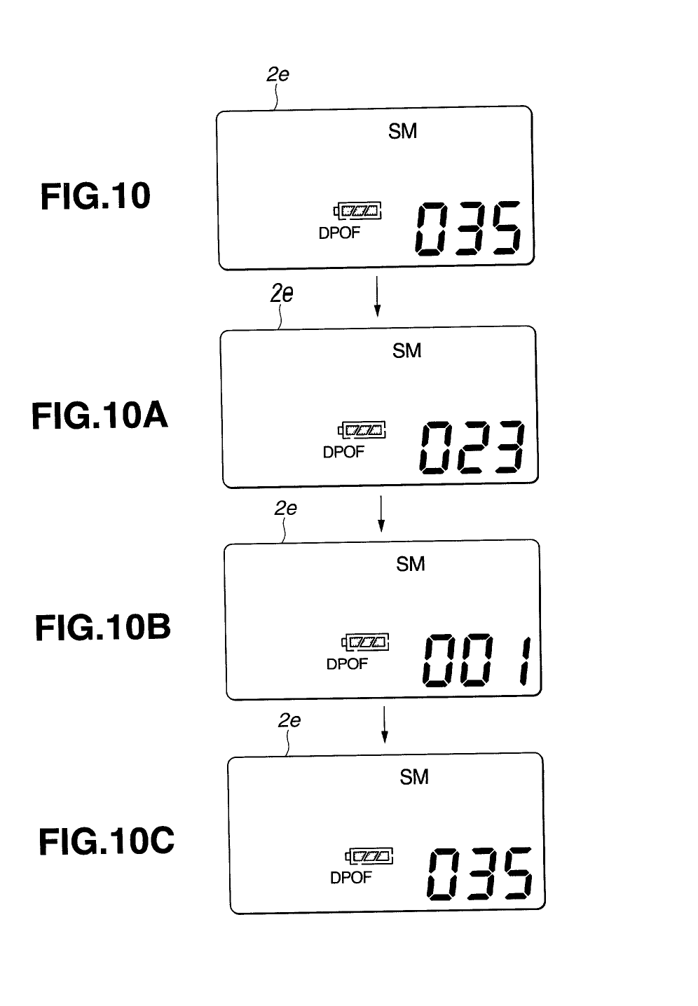

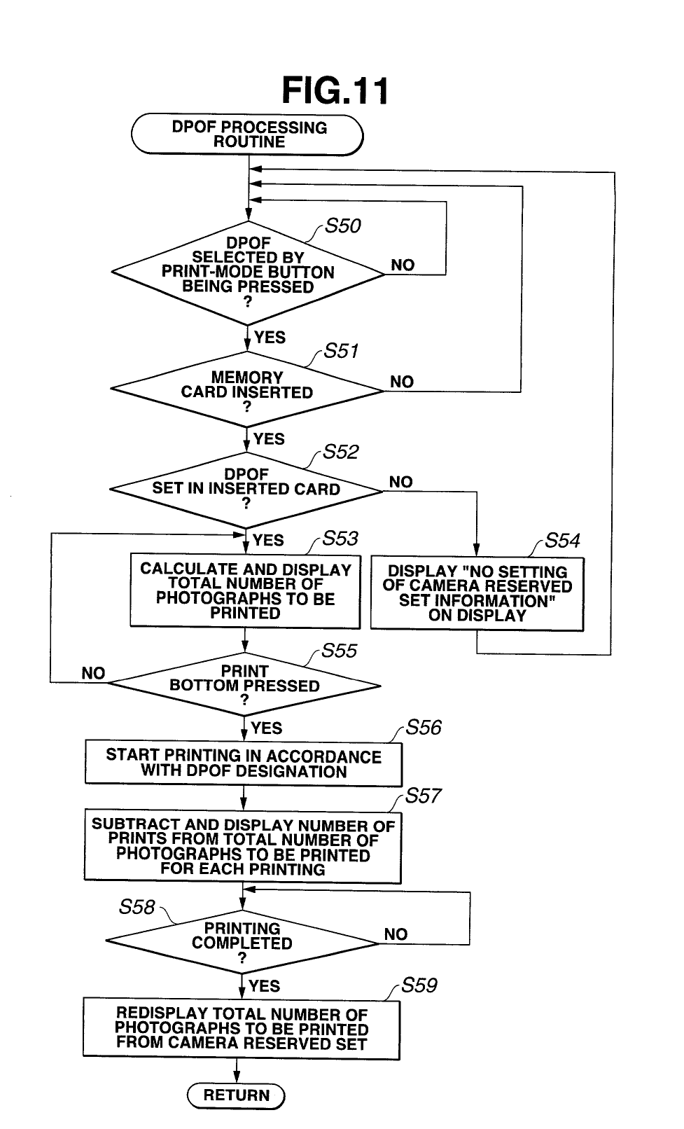

FIGS. 9 though 11 show an embodiment of the printer device which allows the user to take in the total number of prints to be printed. FIG. 9 is a block diagram showing the electrical circuitry of the principle portion mounted on the device shown in FIG. 1, wherein a structural element has been partially added to the structure shown in FIG. 3. FIGS. 10, 10A, 10B and 10C are diagrams showing a display example displaying the total number of prints to be printed and the decremental display of the number of prints during printing pursuant to the camera reserved set information employing the 7-segment display method. FIG. 11 is a flowchart showing the characteristic control action example by the CPU incorporated in the printer device.

In the printer device 1 shown in FIG. 9, structural elements the same as those shown in FIG. 3 are given the same reference numerals and the explanation thereof is omitted. When the first memory card 9a or the second memory card 9b storing image information signals to be printed and print control information is inserted in the print control mode reading unit 82, the printer device 1 distinguishes and recognizes, from the memory card 9, the frame number in which the print control information is written together with image information. Thereafter, the CPU 81 performs operation processing for obtaining the total number of prints to be printed from the print quantity set in the respective frame numbers in which print control information is written, and displays the operated total number of prints on the display unit 2e. After printing is started, the CPU 81 decrements the total number of prints to be printed pursuant to the progress of the print operation after printing is started, and the decremental quantity value is displayed on the display unit 2e so that a countdown is made.

The printer device 1 is structured by comprising a recording paper delivery position detector 89 in addition to the structure shown in FIG. 3.

This recording paper delivery position detector 89 is structured of a plurality of sensors arranged at the take-in position and adjacent to the discharge position of the recording paper 6 on the recording paper delivery path. These plurality of sensors detect the take-in timing and discharge timing of the recording paper 6 and supplies the CPU 81 with such detected timing signals.

The CPU 81 as the control means is structured by comprising at least the print control information recognition unit 81a and an operation processing unit 81b internally, and decodes the data of the various signals from the personal computer 70, decodes data of instruction signals from the operation button 30, decodes print control information from the first or second memory card 9a, 9b, stores print object image data from the personal computer 70 or the first or second memory card 9a, 9b in the image memory 83, makes the display unit 2e display messages, makes the thermal head 20 execute photographic printing, drives the paper feeding/ribbon moving mechanism (not shown), calculates the remaining amount of the battery 8, and the like.

Moreover, with respect to the decoding of the print control information from the first or second memory card 9a, 9b and the display control to the display unit 2e, the CPU 81 recognizes from the memory card 9 the number of frames in which print control information is written together with image information pursuant to, for example, such print control information recognition unit 81a. Further, the operation processing unit 81a performs operation processing to obtain the total number of prints to be printed from the print quantity set in the respective frame numbers in which print control information is written based on such recognition results and performs control such that the total number of prints to be printed is displayed by the display unit 2e. After printing is started, the CPU 81 decrements the total number of prints to be printed pursuant to the progress of the print operation after printing is started, and the decremental quantity value is displayed on the display unit so that a countdown is made.

Next, the control operation characteristic to the printer device shown in FIG. 9 is explained in detail referring to FIGS. 10 through 11. Further, the printer device shown in FIG. 9 also executes the display depicted in, FIGS. 5, 5A, 6, 6A, 6B and 6C in the display unit shown in FIG. 4.

The series of basic operations of the printer device 1 relating to printing as described in FIG. 2 are controlled based on the main routine of the CPU 81. With respect to the operational state during such main routine, for example, by the user suitably pressing the print mode selection button 30c within the operation button 30, if the print mode to be executed is selected to be a print control mode, that is, a DPOF mode, instruction signals showing the DPOF mode execution based on the operation of such operation button 30 is received by the key interface 86 and incorporated in the CPU 81. By recognizing such instruction signals, the CPU 81 activates the processing subroutine for executing the DPOF printing shown in FIG. 11.

The CPU 81 foremost judges whether the print mode to be executed by the print mode button 30c being pressed is DPOF, which is the print control mode, in the judgment processing at step S50, and proceeds the processing to the following step S51 when the DPOF mode is selected. If not, the CPU 81 returns the processing once again to step S50 and repeats such judgment of S50 until the DPOF mode is selected.

The judgment processing at step S51 judges whether a memory card 9a or 9b is inserted in a socket 82a or 82b. In other words, it judges whether the first memory card 9a is inserted in the first socket 82a or whether the second memory card 9b is inserted in the second socket 82b. When either memory card is inserted in its corresponding socket, image signals of print objects and print control information stored in the memory card 9 are incorporated in the CPU 81 by the corresponding memory card interface 82c or 82d. Then, this is temporarily written in the memory 83 under the control of the CPU 81, and the processing proceeds to step S52. Here, when the print control information is read in the CPU 81, the print control information is stored in the memory within the CPU 81, and decoded. Meanwhile, when the memory card 9 is not inserted, the processing is returned to the judgment processing of S50.

Then, at the judgment processing of step S52, the CPU 81 judges whether a DPOF is set as the print control information in the inserted memory card. That is to say, the CPU 81 judges whether a frame in which predetermined print control information is written exists based on the data such as image signals of the respective frames of the print object read in the aforementioned processing pursuant to the print control information recognition unit 81a. When there is a frame in which print control information is written, it is judged that a DPOF is set after recognizing the frame numbers in which image information signals and print control information are written, and, the processing proceeds to step S53. Meanwhile, when there is no frame in which print control information is written, it is judged that a DPOF is not set, and the processing proceeds to the step S54. Pursuant to the processing at step S54, the CPU 81 controls the liquid crystal display controller 85 so as to display on the display unit 2e a display indicating that there is no print information in any frame and DPOF has not been set, for example, as shown in FIG. 5A.

In the display shown in FIG. 5A, “DPOF” showing that the DPOF mode is selected, or set, which is a print control mode on the screen of the display unit 2e, a battery remaining amount display, and a “non” employing the 7-segment display method representing that the DPOF is not set are displayed. When displaying a message utilizing the 7-segment display method that the DPOF is not set, it is also possible to display on the display unit 2e “Non” or “NON” in which three 7-segments are used and uppercase letters and lowercase letters are replaced as shown in FIG. 6 and FIG. 6A for example, or it may also display “No” or “no” in which two 7-segments are used and uppercase letters and lowercase letters replaced as shown in FIG. 6B and FIG. 6C. Further, in addition to the character display of alphabets by using the 7-segment display method as described above, it is also possible to display on the display unit 2e numerals such as “000” shown in FIG. 7 for example as a display that the DPOF is not set. Here, also considered may be “00” utilizing two 7-segments or “0” utilizing one 7-segment. Needless to say, the selection of such displays may be set by freely switching the setting with the user device.

Moreover, the section in which the message that the print control mode is not set is displayed is within the same display section as with the section displaying the frame number, print decremental value and total number of prints to be printed or the print quantity.

Thereafter, the CPU 81 returns the processing to step S50 after making the display unit 2e displaying a message that there is no camera reserve set information.

Meanwhile, when it is judged by the judgment processing at step S52 that a DPOF is not set, the CPU 81 performs operation processing in order to obtain the total number of prints to be printed from the default value priorly set in the respective frame numbers in which print control information is written based on the recognition results at step S52 pursuant to the operation processing unit 81b. Then, the CPU 81 controls the liquid crystal display controller 85 so as to display on the display unit 2e the total number of prints to be printed as shown in FIG. 5. Moreover, in the display shown in FIG. 5, “DPOF” showing that the DPOF mode is selected, or set, which is a print control mode on the screen of the display unit 2e, a battery remaining amount display, and, for example, a “035” for representing the total number of prints in the camera reserve set information are displayed.

Thereafter, the CPU 81 advances the processing to step S55, and judges whether the print button 30b is pressed by recognizing the instruction signals supplied via the key interface 86 during such judgment processing. When the print button 30b is not pressed, the processing of S53 is repeated until the print button 30b is pressed. In other words, the processing is returned to said step S53 and the display of the total number of prints to be printed is displayed again for notifying the user that the system is in the state where printing is possible. Meanwhile, when it is judged that the print button 30b is pressed, the CPU 81 advances the processing to step S56, and starts the printing operation in the DPOF mode by controlling the print controller 87 so as to print the frames corresponding to the number based on the decoded print control information.

After printing is started, the CPU 81 decrements at the processing of step S57 the print quantity for each printing from the total number of prints to be printed pursuant to the progress of the print operation after printing is started with the operation processing unit 81b, and the decremental quantity value is displayed on the display unit 2e so that a countdown is made. Here, with the operation processing unit 81b, the CPU 81 performs decrement processing in order to obtain the total number of prints to be printed in a timing based on the take-in timing signals or the discharge timing signals of the recording paper 6 from the recording paper delivery position detector 89 supplied after the completion of one sheet of printing, and displays the decremental value on the display unit 2e for each printing.

Thereafter when the printing operation is finished, the CPU 81 judges whether the print operation is finished with the judgment processing at the next step S58. When the print operation is not finished, the judgment processing of S58 is repeated. When the print operation is finished, in the judgment processing at step S59, the total number of prints to be printed (c.f. FIG. 5 or FIG. 10) to which a reserve set is made in the print control information is displayed once again, and the processing is returned to the main routine after notifying the user that the print operation is finished.

In this type of embodiment, the total number of prints of the cameral reserved set information employing the 7-segment display method is displayed on the screen of the display 2e in addition to “DPOF” and the battery remaining amount as shown in FIG. 10. During printing thereafter, a countdown display which decrements from the total number of prints to be printed for each printing is successively displayed as shown in FIG. 10A. When the printing operation eventually ends, as shown in FIG. 10B, a countdown display is made from “001” to “000” not shown. Then, simultaneously with the completion of the print operation; in other words, after all printing is finished, the total number of camera reserved set information to be printed as shown in FIG. 10C is displayed once again, or redisplayed instead of the decremental quantity value.

Therefore, by displaying on the display unit 2e the total number of prints to be printed with the 7-segment display method, for example, upon executing the DPOF print mode by inserting a memory card having written thereof image signals of print objects and print control information as described above, it is possible to notify the user with certainty of the total number of print to be printed prior to the start of printing.

Further, after the start of printing, as the total number of prints to be printed pursuant to the progress of print operation decrements and the decremental quantity value is displayed on the display unit 2e so that a countdown is made, the user is thereby able to forecast the time until printing is finished.

Moreover, as “DPOF” as described above showing that the DPOF mode is selected is displayed on the screen of the display unit 2e representing the total number or prints to be printed and the countdown display from the start of printing to the completion thereof, the user is able to recognize that the DPOF mode is being executed at a glance.

Thereby, provided is a printer device comprising a superior print function compatible with DPOF not available in the related art.

In addition, although it was described above that the total number of prints to be printed and the decremental display are displayed when the selected and executed print mode is the DPOF mode, but the present invention is not limited thereto, and, needless to say, it is possible to display the total number of prints to be printed and the decremental display when executing a plurality of prints for each frame number in other print modes, and similar effects may be obtained thereby.

Thus, according to the present invention, provided is a printer device comprising a superior print function compatible with DPOF.

According to the present invention as described above, provided is a printer device capable of notifying a user by displaying via a display means that a frame in which print control information is written does not exist in a storage medium such as a memory card.

Moreover, according to the present invention, provided is a printer device capable of allowing a user to take in the total number of prints prior to the start of printing, as well as to estimate the time from the start of printing to the completion thereof by displaying the total number of prints to be printed and a decremental display from such total number for each printing.

While this invention has been described in detail referring to one preferred embodiment of the invention, it should be understood that the invention is not limited to that precise embodiment. Rather, many modifications and variation will be apparent to those skilled in the art without departing from the scope and sprit of the invention as defined in the appended claims.

What is claimed is:

1. A printer device capable of printing image information photographed with an electronic photograph device, comprising:
mode setting means capable of setting a print control mode in which said image information is printed based on said print control information written corresponding to said image information;
distinguishing means for distinguishing a frame number to which said print control information is written and a frame number to which said print control information is not written when said print control mode is set;
calculating means for calculating a total number of prints to be printed from said number of prints set in said respective frame numbers distinguished as having said print control information written therein; and
display means for displaying said total number of prints calculated when said print control mode is set, and displaying a message that said print control mode is not set when said print control mode is not set.

2. A printer device according to claim 1, wherein said image information and said print control information are stored in a storage medium which is freely attachable/detachable in said printer device.

3. A printer device according to claim 1, wherein said calculating means subtracts said total number of prints to be printed along with said progress of said print operation, and said display means displays that a countdown is made with respect to said value of said subtracted number of prints.

4. A printer device according to claim 3, wherein said calculating means subtracts said number of prints to be printed in a timing when said recording paper is discharged after said completion of printing or in a timing when said recording paper is taken in prior to printing.

5. A printer device according to claim 1, wherein said image information and said print control information are stored in a storage medium which is freely attachable/detachable in said printer device, said calculating means Calculates said total number of prints to be printed based on said print control information stored in said storage medium and subtracts said number of prints to be printed along with said progress of said print operation, and said display means displays that the countdown is made with respect to said value of said subtracted number prints.

6. A printer device according to claim 5, wherein said calculating means subtracts said number of prints to be printed in a timing when said recording paper is discharged after said completion of printing or in a timing when said recording paper is taken in prior to printing.

7. A printer device according to claim 1, wherein a part in which a message that said print control mode is not set is displayed is said same part in which said frame number displayed in said display means a subtracted print value and total number of prints to be printed are displayed.

8. A printer device according to claim 3, wherein said calculating means redisplays said total number of prints to be printed instead of said subtracted print value after said printing all pages is finished.

9. A printer device according to claim 3, wherein said calculating means redisplays said total number of prints to be printed after said printing all pages is finished.

10. A printer device capable of printing image information based on print control information written corresponding to said image information photographed with an electronic photograph device, comprising:
mode setting means capable of setting a print control mode in which print control information written corresponding to said image information is read;
judging means for judging whether or not a frame in which predetermined print control information is written exists when said print control mode is set; and
display control means for displaying a message that said print control information is not set in any frame when said judging means judges that said print control information is not set to any frame.

11. A printer device according to claim 10, wherein said print control information is information in which a number of prints is set corresponding to image information of said respective frames.

12. A printer device according to claim 10, wherein said image information photographed with said electronic photograph device and said print control information set corresponding to said predetermined image information are stored in a storage medium which is freely attachable/detachable in said printer device.

13. A printer device, comprising:
mode setting means for setting a print control mode in which print control information written corresponding to image information is read;
judging means for judging whether or not a frame in which said image information and said print control information are written exists when said print control mode is set;
display means capable of displaying at least information of printing; and
display control means for making said display means display a message that said print control information is not set in any frame when said judging means judges that said print control information is not set in any frame.

14. A printer device according to claim 13, wherein image information photographed with said electronic photograph device and said print control information set corresponding to said predetermined image information are stored in a storage medium which is freely attachable/detachable in said printer device.

15. A printer device according to claim 13, wherein said display control means makes said display means display a message that said print control information is not set in any frame by means of a character display employing a 7 segment display method.

16. A printer device according to claim 13, wherein said display control means makes said display means display numeral “0” when said print control information is not set in any frame.

17. A printer device according to claim 13, wherein said display control means makes said display means display “DPOF” in accordance with said setting a mode to said print control mode.

18. A printer device according to claim 13, wherein said print control information is information on a number of prints recoded corresponding to said frame.

19. A printer device according to claim 13, wherein said part in which a message that said print control mode is not set is displayed is said same part in which number of prints to be printed is displayed in said display means.
